(19) United States
(12) Patent Application Publication
(10) Pub. No.: US 2024/0378436 A1
(43) Pub. Date: Nov. 14, 2024

(54) Partial Quantization To Achieve Full Quantized Model On Edge Device

(71) Applicant: NXP USA, Inc., Austin, TX (US)

(72) Inventors: Manish Kumar Bajaj, Round Rock, TX (US); Bin Jiao, Tianjin (CN)

(21) Appl. No.: 18/479,875

(22) Filed: Oct. 3, 2023

(30) Foreign Application Priority Data
May 11, 2023 (CN) 202310532613.9

(51) Int. Cl. G06N 3/08

(52) U.S. Cl. CPC G06N 3/08

(57) ABSTRACT

A method for partial quantization to achieve full quantized model includes quantizing a plurality of weights and a respective activation function from each of a plurality of respective layers of an original Machine Learning Model (MLM) to generate a quantized MLM comprising a plurality of frozen quantized weights. The plurality of frozen quantized weights are extracted from at least one frozen layer of the layers of the quantized MLM. The plurality of weights are quantized from at least one updated layer of an updated MLM to generate a plurality of updated quantized weights. The respective activation function of the at least one updated layer of the updated MLM is quantized from a difference between the original MLM and the updated MLM, to form a respective quantized activation function. A new quantized MLM is generated from the frozen quantized weights, the updated quantized weights and the respective quantized activation function.

### FIELD

This disclosure relates generally to neural networks, and more specifically to partial quantization of a neural network to achieve a fully quantized model on an Edge device.

### BACKGROUND

Neural networks consist of a series of interconnected structures or layers, inspired by the neurons of a human brain. Each layer (e.g. neuron) may include the summation of multiple weighted inputs, which will produce an output if the summation exceeds a respective activation level. A functional model using neural networks may be built with sample data, known as training data, to make predictions or decisions without explicit programming. Such models may also continue to be refined with successive training cycles providing statistical learning. A trained model, may then use this adaptive machine learning with a subsequent data set to predict an appropriate response.

Machine learning is being increasingly used by portable devices such as cell phones and wearable electronic devices. Due to the computing power and storage limitations of these portable devices, quantization may be used to reduce the model's complexity. Typically, training and quantization of a machine learning model requires the portable device to communicate over the internet cloud or with another processor having more computing resources, thus exposing the portable device to potential data security issues and generally limiting operational flexibility.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 is a schematic view of an embodiment of a neuron forming the basis of a neural network.

FIG. 2 is a graphical view of an embodiment of affine mapping of a real number to an integer number.

FIG. 3 is a flowchart representation of a method for partial quantization to achieve a fully quantized model, in accordance with an embodiment of the present disclosure.

FIG. 4 is a flowchart representation of a usage of a partial quantization tool to achieve a fully quantized model, in accordance with an embodiment of the present disclosure.

FIG. 5 is a flowchart representation of a training and quantization system, in accordance with an embodiment of the present disclosure.

FIG. 6 is a flowchart representation of a method for partial quantization to achieve full quantized model on Edge device, in accordance with an embodiment of the present disclosure.

FIG. 7 is a flowchart representation of another method for partial quantization to achieve full quantized model on Edge device, in accordance with an embodiment of the present disclosure.

FIG. 8 is a flowchart representation of another method for partial quantization to achieve full quantized model on Edge device, in accordance with an embodiment of the present disclosure.

### DETAILED DESCRIPTION

Embodiments described herein provide for the training and quantization of a Machine Learning Model (MLM) on an Edge device without requiring the resources of a more powerful host machine, nor a connection to a host or a similar cloud-based computing platform. An Edge device as defined herein includes hardware that controls dataflow at a network boundary such as a cellular phone, a wearable fitness tracking device, portable devices and the like. Edge devices typically have limited processing power and memory storage compared to host machines.

Partial training and quantization of an MLM directly on the Edge device avoids the typical requirement of providing a full training dataset on the device, where the full dataset may include proprietary information. Furthermore, by quantizing an MLM directly on the device, security issues associated with the host are avoided (e.g., including malware, data hacking and cloning). Additional personalization of the Edge device may also be realized without the typical data safety concern.

Partial training and quantization on the device may also facilitate “transfer learning” whereby a device trained by one set of data may be extended or modified to learn with related data by modifying only a subset of the many layers of the MLM. In one non-limiting example of transfer learning, a device is trained to recognize a sedan. Through transfer learning the device is subsequently taught to recognize a truck or a bus. A new MLM with updated layers may thereby be quantized by retaining the quantization of weights associated with frozen layers (e.g., those that have not been updated as a result of transfer learning), by quantizing the weights associated with updated layers, and by quantizing the activation functions based on changes to the scaling and integer zero point between the original MLM and the updated MLM (having the updated layers).

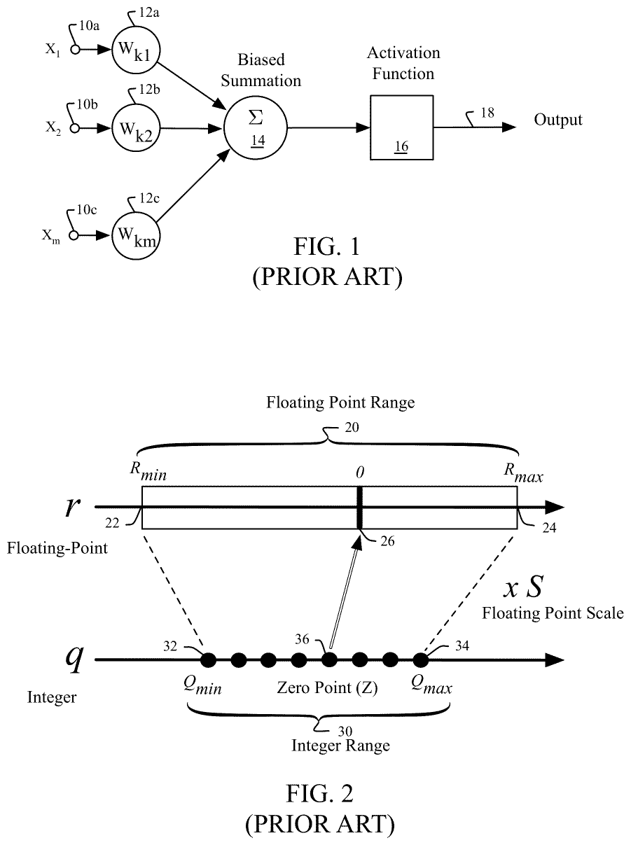

FIG. 1 shows an example of a neuron, which forms the basis of an MLM. In one example, a neuron may include a plurality of inputs (e.g., tensor inputs) 10a, 10b and 10c (generally 10). Each input 10 is modified by a respective weight 12a, 12b and 12c (generally 12) and summated with a biased summation 14. If the result of the biased summation exceeds a threshold defined by the activation function 16, an output 18 is generated. The example neuron of FIG. 1 may define a single layer from a plurality of interconnected layers of an MLM.

FIG. 2 shows an example of affine mapping for quantization of a floating point number to an integer number. Specifically, a floating point range 20 includes a floating point minimum (Rmin) 22, a floating point maximum (Rmax) 24 and floating point zero 26. The affine mapping of FIG. 2 further includes an integer range 30. The integer range 30 includes an integer minimum (Qmin) 32, an integer maximum (Qmax) 34 and an integer zero point (Z) 36. The example of FIG. 2 shows an asymmetric quantization of floating point numbers to integer numbers based on a scaling difference between Rmax 24−Rmin 22 and Qmax 34−Qmin 32, in addition to a potential shift of the floating point zero 26 to an integer zero point 36 within the integer range 30. The affine mapping of FIG. 2 reduces the numbers represented by floating point values to integer values, which will require less memory storage and a reduction in computing resources during subsequent processing of the integer values.

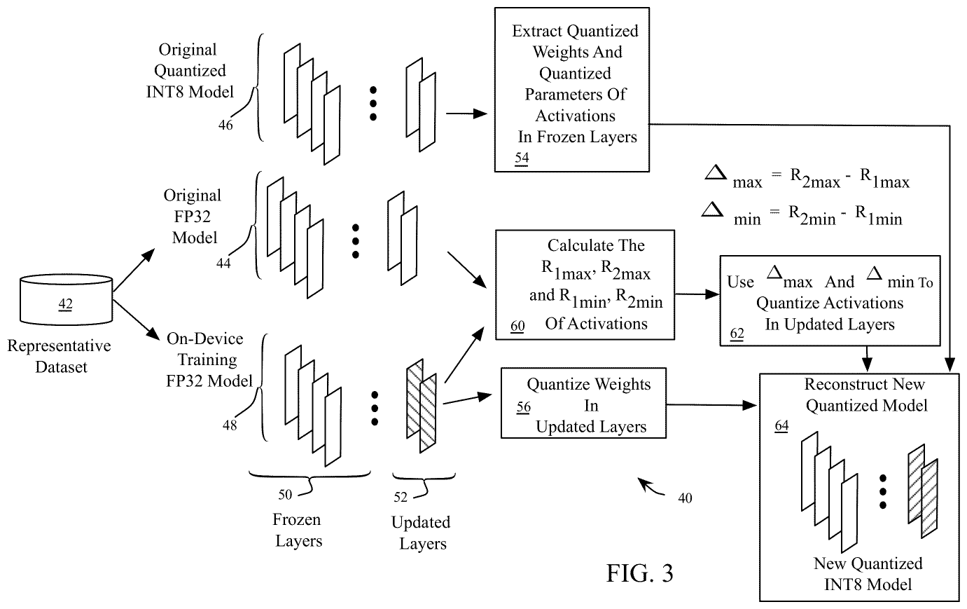

FIG. 3 is a flowchart representation of a method for partial quantization to achieve a fully quantized model, in accordance with an embodiment 40 of the present disclosure. In one embodiment, the representative dataset 42 is a subset of a training dataset used to train an original 32 bit floating point (FP32) model 44 to create the original quantized INT8 model 46. Therefore, the model 46 is a pre-quantized model created from the original FP32 model 44. The original quantized INT8 model 46 is already quantized using more than one image before being deployed to the Edge device. The representative dataset 42 may be a subset of data generated or produced on the Edge device itself and used to train the original FP32 model 44 through transfer learning. Specifically, only one image is required from the representative dataset 42 by the original FP32 model 44 and the updated FP32 model 48 to calculate the R1max, R1min, R2max and R2min in the updated layers 52, and ultimately to reconstruct a new quantized model 64.

It should be appreciated that the example of FIG. 3 uses FP32 and INT8 models for case of illustration but should not be considered limited to these numeric ranges. The representative dataset 42 may also be used to quantize an on-device training (or updated) FP32 model 48 for transfer learning. The updated model 48 includes frozen layers 50, which remain the same as the corresponding layers of the original FP32 model 44. The updated model 48 further includes updated layers 52, which are different than the corresponding layers of the original FP32 model 44.

In the embodiment 40, quantized weights are extracted 54 from the frozen layers 50 of the model 46 to form frozen quantized weights. The weights of the updated layers 52 of the updated model 48 are quantized 56 to generate updated quantized weights. With reference to FIG. 2 and FIG. 3, at 60 the floating point maximum (Rmax) and floating point minimum (Rmin) of the range of activation floating point values for the original FP32 model 44 (respectively, R1max and R1min), and for the updated FP32 model 48 (respectively, R2max and R2min) are determined. A Delta-max and a Delta-min value are determined at 62 in accordance with the following equations [1] and [2]:

$$\begin{matrix}Delta - max = R 2 max - R 1 max & [ 1 ] \\ Delta - min = R 2 min - R 1 min & [ 2 ]\end{matrix}$$

At 64, a new quantized model is generated with the frozen quantized weights and quantized parameters of activations extracted from 54, the updated quantized weights quantized from 56, and the updated quantized activation functions of the updated model 48, quantized with the Delta-max and Delta-min values from 62. In one embodiment, the quantized parameters of activations include scaling and integer zero point values.

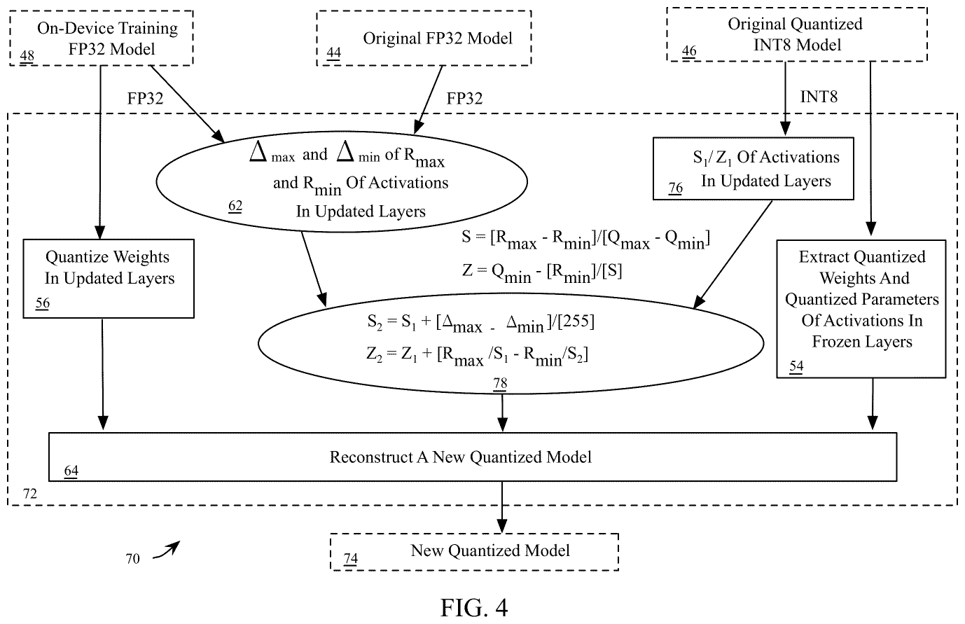

FIG. 4 is a flowchart representation of a usage of a partial quantization tool to achieve a fully quantized model, in accordance with an embodiment 70 of the present disclosure. Referring to FIG. 4, the embodiment 70 further defines the method for reconstructing the new quantized model as shown in embodiment 40 of FIG. 3. Similar to FIG. 3, the partial quantization tool 72 receives inputs from an original FP32 model 44, a quantized INT8 model 46, and an updated FP32 model 48, and generates a new quantized model 74 from the model reconstruction step 64. With reference to FIG. 2 and FIG. 4, the partial quantization tool 72 determines an original scale (S1) and an original integer zero point (Z1) at 76 in accordance with the following equations [3] and [4]:

$$\begin{matrix}S = ( Rmax - Rmin ) / ( Qmax - Qmin ) & [ 3 ] \\ Z = Qmin - Rmin / S & [ 4 ]\end{matrix}$$

The partial quantization tool 72 determines an updated scale (S2) and an updated integer zero point (Z2) at 78 in accordance with the following equations [5] and [6]:

$$\begin{matrix}S 2 = S 1 + ( Delta - max - Delta - min ) / 255 & [ 5 ] \\ Z 2 = Z 1 + ( R 1 min / S 1 ) - ( R 2 min / S 2 ) & [ 6 ]\end{matrix}$$

The equation [5] is an example based on quantizing a floating point number to an eight bit integer value (INT8), hence the denominator of 255 representing one less than an integer maximum of an integer range (of 256). For embodiments based on a different integer range, the denominator should be suitably modified to match the new integer range minus one.

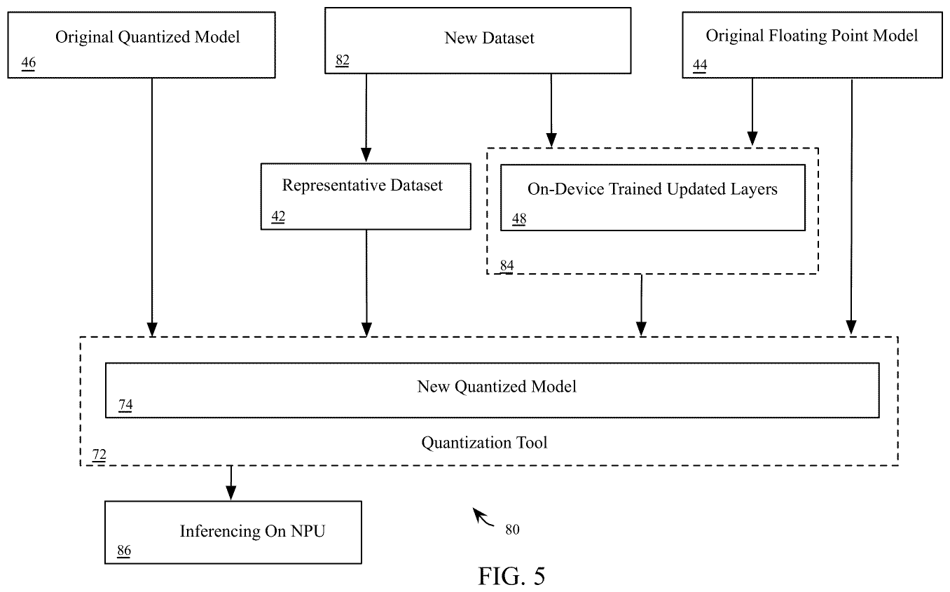

FIG. 5 is a flowchart representation of a training and quantization system, in accordance with an embodiment 80 of the present disclosure. A new dataset is provided to train an updated model 48 with updated layers. In one example, the new dataset 82 is used to train the updated model 48 using a Tensor Flow (TF) Lite program 84. With reference to FIG. 3 and FIG. 5, a representative dataset 42 (derived as a subset of the new dataset 82) is used with the original quantized model 46, the updated model 48 and the original floating point model 44 to generate a new quantized model 74, using the partial quantization tool of FIG. 4. In one embodiment, the representative dataset 42, the original quantized model 46, the updated model 48 and the original floating point model 44 are all stored on an Edge device, without connection to other computing resources (e.g., a host or cloud connection). The new quantized model 74 may then be used by a Neural Processing Unit (NPU) inferencing to perform transfer learning.

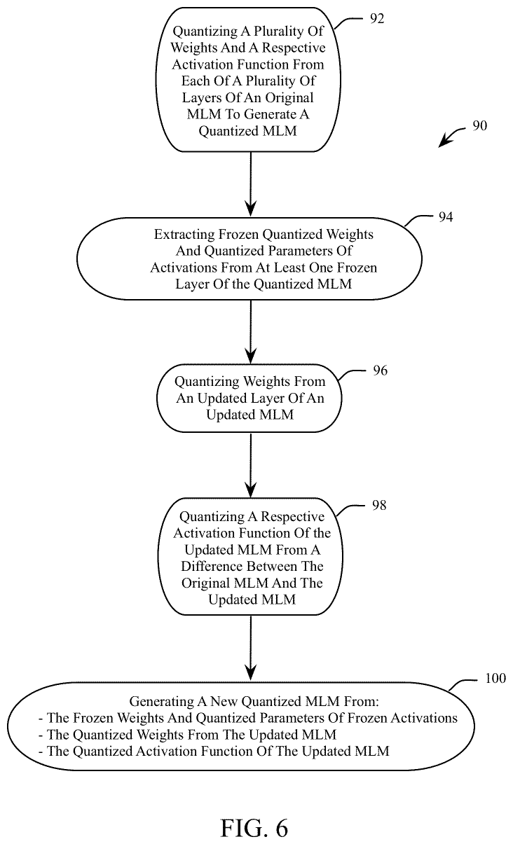

FIG. 6 shows an embodiment 90 of a method for partial quantization to achieve full quantized model. With continued reference to FIG. 3 and FIG. 4, at 92 a plurality of weights and a respective activation function of an original MLM 44 are quantized to generate a quantized MLM 46. At 94, frozen quantized weights and quantized activations parameters are extracted 54 from the quantized MLM. At 96, weights from an updated layer 52 of an updated MLM 48 are quantized 56. At 98, a respective activation function of the updated MLM 48 is quantized from a difference between the original MLM 44 and the updated MLM 48. At 100, a new quantized MLM 64 is generated from the frozen weights, the quantized weights from the updated MLM 48 and the quantized activation function of the updated MLM 48.

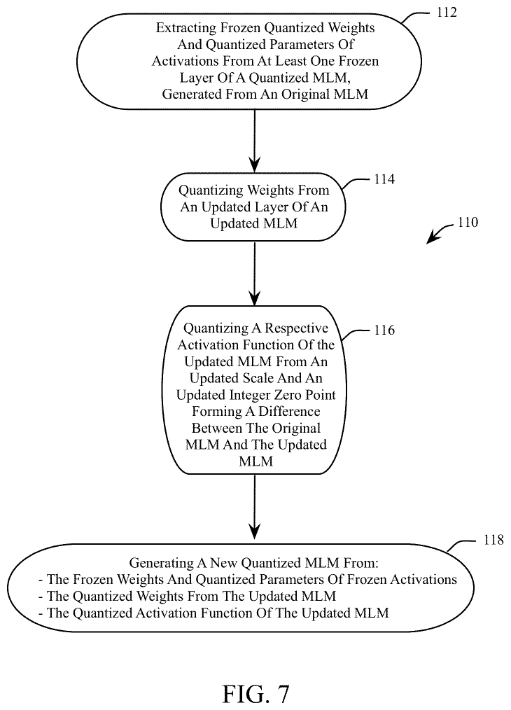

FIG. 7 shows an embodiment 110 of a method for partial quantization to achieve full quantized model. With continued reference to FIG. 3 and FIG. 4, at 112 frozen quantized weights and quantized activations parameters are extracted 54 from at least one frozen layer 50 of a quantized MLM 46, generated from an original MLM 44. At 114, weights from an updated layer 52 of an updated MLM 48 are quantized 56. At 116, a respective activation function of the updated MLM 48 is quantized from an updated scale S2 and an updated integer zero point Z2 (see 78 of FIG. 4). At 118, a new quantized MLM 64 is generated from the frozen weights, the quantized weights from the updated MLM 48 and the quantized activation function of the updated MLM 48.

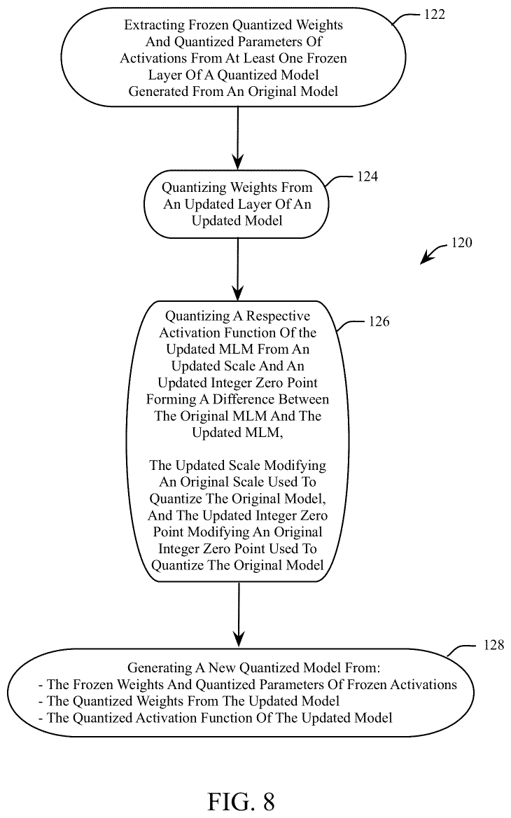

FIG. 8 shows an embodiment 120 of a method for partial quantization to achieve full quantized model. With continued reference to FIG. 3 FIG. 4, and FIG. 5 at 122 frozen quantized weights are extracted 54 from at least one frozen layer 50 of a quantized model 46, generated from an original model 44. At 124, weights from an updated layer 52 of an updated model 48 are quantized 56. At 126, a respective activation function of an updated layer 52 of the updated model 48 is quantized from an updated scale S2 and an updated integer zero point Z2 (see 78 of FIG. 4), wherein the updated scale S2 modifies an original scale S1 used to quantize the original model 44, and the updated zero integer zero point Z2 modifies an original integer zero point Z1 used to quantize the original model 44. At 128, a new quantized model 64 is generated from the frozen weights, the quantized weights from the updated model 48 and the quantized activation function of the updated model 48.

As will be appreciated, at least some of the embodiments as disclosed include at least the following. In one embodiment, a method for partial quantization to achieve full quantized model comprises quantizing a plurality of weights and a respective activation function from each of a plurality of respective layers of an original Machine Learning Model (MLM) to generate a quantized MLM comprising a plurality of frozen quantized weights, each layer comprising a summation of a plurality of inputs, each input multiplied by a respective one of the plurality of weights, and the summation gated by the respective activation function. The plurality of frozen quantized weights of at least one frozen layer are extracted from the layers of the quantized MLM. The plurality of weights from at least one updated layer of an updated MLM are quantized to generate a plurality of updated quantized weights, wherein the at least one updated layer of the updated MLM is generated by updating the respective layer of the original MLM. The respective activation function of the at least one updated layer of the updated MLM is quantized from a difference between the original MLM and the updated MLM, to generate a respective quantized activation function. A new quantized MLM is generated from the frozen quantized weights, the updated quantized weights and the respective quantized activation function.

Alternative embodiments of the method for partial quantization to achieve full quantized model include one of the following features, or any combination thereof. The difference between the original MLM and the updated MLM is determined by determining an updated scale comprising adding a ratio to an original scale of the original MLM, wherein the ratio is determined by a delta-difference between a delta-max and a delta-min, divided by one less than an integer maximum of an integer range used for quantizing the respective activation function of the updated MLM. The delta-max is determined by subtracting an original maximum of an original floating point range of the activation function of each layer of the original MLM from an updated maximum of an updated floating point range of the activation function of each layer of the updated MLM. The delta-min is determined by subtracting an original minimum of an original floating point range of the activation function of each layer of the original MLM from an updated minimum of an updated floating point range of the activation function of each layer of the updated MLM. The difference between the original MLM and the updated MLM is determined by determining an updated integer zero point by adding an offset to an original integer zero point of the original MLM, wherein the offset is determined by subtracting an updated minimum of an updated floating point range of the activation function of each layer of the updated MLM divided by an updated scale, from an original minimum of an original floating point range of the activation function of each layer of the original MLM divided by an original scale of the original MLM. The original integer zero point is determined by subtracting the original minimum of the original floating point range of the activation function of each layer of the original MLM, divided by the original scale, from an integer minimum of an integer range used for quantizing the respective activation function of the quantized MLM. The original scale is determined by subtracting the original minimum of the original floating point range from the original maximum of the original floating point range, divided by the integer minimum of the integer range subtracted from an integer maximum of the integer range. The plurality of weights are quantized from the at least one updated layer of the updated MLM with the original MLM, the quantized MLM, the updated MLM and a representative dataset collected on an Edge device, wherein the representative dataset is a subset of a dataset used to train the updated MLM. The quantized MLM further comprises quantizing the plurality of weights from each one of a plurality of tensor inputs of the original MLM. Generating the quantized MLM further comprises quantizing the plurality of weights from each one of a plurality of channels of the original MLM.

In another embodiment, a method for partial quantization to achieve full quantized model comprises extracting a plurality of frozen quantized weights from each frozen layer of a quantized Machine Learning Model (MLM), wherein the quantized MLM is generated by quantizing an original MLM. A plurality of updated weights are quantized from an updated MLM to generate a plurality of updated quantized weights, wherein the updated MLM is generated by updating at least one layer of the original MLM to form at least one updated layer. A respective activation function of each updated layer from the updated MLM is quantized from a difference between the original MLM and the updated MLM to generate a quantized activation function, wherein the difference comprises an updated scale and an updated integer zero point. A new quantized MLM is generated from the frozen quantized weights, the updated quantized weights and the respective quantized activation function of each updated layer.

Alternative embodiments of the method for partial quantization to achieve full quantized model include one of the following features, or any combination thereof. The updated scale is determined by adding a ratio to an original scale of the original MLM, wherein the ratio is determined by a delta-difference between a delta-max and a delta-min, divided by one less than an integer maximum of an integer range used for quantizing the respective quantized activation function of the updated MLM. The delta-max is determined by subtracting an original maximum of an original floating point range of the activation function of each layer of the original MLM from an updated maximum of an updated floating point range of the activation function of each layer of the updated MLM and determining the delta-min by subtracting an original minimum of the original floating point range of the activation function of each layer of the original MLM from an updated minimum of the updated floating point range of the activation function of each layer of the updated MLM. The updated integer zero point is determined by adding an offset to an original integer zero point of the original MLM, wherein the offset is determined by subtracting from an original minimum of an original floating point range of the activation function of each layer of the original MLM divided by an original scale of the original MLM, an updated minimum of an updated floating point range of the activation function of updated layer of the updated MLM divided by an updated scale. The original integer zero point is determined by subtracting from an integer minimum of an integer range used for quantizing the respective activation function of the quantized MLM, a quantized minimum of a quantized floating point range of the activation function of each layer of the quantized MLM, divided by the original scale, and the original scale is determined by subtracting the original minimum of the original floating point range from the original maximum of the original floating point range, divided by the integer minimum of the integer range subtracted from an integer maximum of the integer range.

In another embodiment, a method for partial quantization to achieve full quantized model comprises extracting a plurality of frozen quantized weights and quantized activations parameters from each frozen layer of a quantized model, wherein the quantized model is generated by quantizing an original model. A plurality of updated weights are quantized from an updated model to generate a plurality of updated quantized weights, wherein the updated model is generated by updating at least one layer of the original model to form at least one updated layer. A respective activation function of each updated layer is quantized from the updated model from a difference between the original model and the updated model to generate a quantized activation function, wherein the difference comprises an updated scale and an updated integer zero point, the updated scale modifying an original scale used to quantize the original model with a ratio proportional to a floating point range difference between the updated model and the original model, and the updated integer zero point modifying an original integer zero point used to quantize the original model with a scaled difference between the floating point range minimums of the updated model and the original model. A new quantized model is generated from the frozen quantized weights and quantized activations parameters, the updated quantized weights and the respective quantized activation function of each updated layer.

Alternative embodiments of the method for partial quantization to achieve full quantized model include one of the following features, or any combination thereof. The updated model is trained with a new dataset stored on an Edge device. A plurality of weights and a respective activation function from each of a plurality of respective layers of the original model are quantized with a representative dataset, wherein the representative dataset is a subset of the new dataset. The updated model adapts to the new dataset through transfer learning. Inferencing is performed with a neural processing unit and the new quantized model to perform transfer learning on an Edge device.

Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A method for partial quantization to achieve full quantized model comprising:
quantizing a plurality of weights and a respective activation function from each of a plurality of respective layers of an original Machine Learning Model (MLM) to generate a quantized MLM comprising a plurality of frozen quantized weights, each layer comprising a summation of a plurality of inputs, each input multiplied by a respective one of the plurality of weights, and the summation gated by the respective activation function;
extracting the plurality of frozen quantized weights of at least one frozen layer from the layers of the quantized MLM;
quantizing the plurality of weights from at least one updated layer of an updated MLM to generate a plurality of updated quantized weights, wherein the at least one updated layer of the updated MLM is generated by updating the respective layer of the original MLM;
quantizing the respective activation function of the at least one updated layer of the updated MLM from a difference between the original MLM and the updated MLM, to generate a respective quantized activation function; and
generating a new quantized MLM from the frozen quantized weights, the updated quantized weights and the respective quantized activation function.

2. The method of claim 1 further comprising determining the difference between the original MLM and the updated MLM by determining an updated scale comprising adding a ratio to an original scale of the original MLM, wherein the ratio is determined by a delta-difference between a delta-max and a delta-min, divided by one less than an integer maximum of an integer range used for quantizing the respective activation function of the updated MLM.

3. The method of claim 2 further comprising determining the delta-max by subtracting an original maximum of an original floating point range of the activation function of each layer of the original MLM from an updated maximum of an updated floating point range of the activation function of each layer of the updated MLM.

4. The method of claim 2 further comprising determining the delta-min by subtracting an original minimum of an original floating point range of the activation function of each layer of the original MLM from an updated minimum of an updated floating point range of the activation function of each layer of the updated MLM.

5. The method of claim 1 further comprising determining the difference between the original MLM and the updated MLM by determining an updated integer zero point by adding an offset to an original integer zero point of the original MLM, wherein the offset is determined by subtracting an updated minimum of an updated floating point range of the activation function of each layer of the updated MLM divided by an updated scale, from an original minimum of an original floating point range of the activation function of each layer of the original MLM divided by an original scale of the original MLM.

6. The method of claim 5 wherein the original integer zero point is determined by subtracting the original minimum of the original floating point range of the activation function of each layer of the original MLM, divided by the original scale, from an integer minimum of an integer range used for quantizing the respective activation function of the quantized MLM.

7. The method of claim 6 wherein the original scale is determined by subtracting the original minimum of the original floating point range from the original maximum of the original floating point range, divided by the integer minimum of the integer range subtracted from an integer maximum of the integer range.

8. The method of claim 1 further comprising quantizing the plurality of weights from the at least one updated layer of the updated MLM with the original MLM, the quantized MLM, the updated MLM and a representative dataset collected on an Edge device, wherein the representative dataset is a subset of a dataset used to train the updated MLM.

9. The method of claim 1 wherein generating the quantized MLM further comprises quantizing the plurality of weights from each one of a plurality of tensor inputs of the original MLM.

10. The method of claim 1 wherein generating the quantized MLM further comprises quantizing the plurality of weights from each one of a plurality of channels of the original MLM.

11. A method for partial quantization to achieve full quantized model comprising:
extracting a plurality of frozen quantized weights from each frozen layer of a quantized Machine Learning Model (MLM), wherein the quantized MLM is generated by quantizing an original MLM;
quantizing a plurality of updated weights from an updated MLM to generate a plurality of updated quantized weights, wherein the updated MLM is generated by updating at least one layer of the original MLM to form at least one updated layer;
quantizing a respective activation function of each updated layer from the updated MLM from a difference between the original MLM and the updated MLM to generate a quantized activation function, wherein the difference comprises an updated scale and an updated integer zero point; and
generating a new quantized MLM from the frozen quantized weights, the updated quantized weights and the respective quantized activation function of each updated layer.

12. The method of claim 11 wherein the updated scale is determined by adding a ratio to an original scale of the original MLM, wherein the ratio is determined by a delta-difference between a delta-max and a delta-min, divided by one less than an integer maximum of an integer range used for quantizing the respective quantized activation function of the updated MLM.

13. The method of claim 12 further comprising determining the delta-max by subtracting an original maximum of an original floating point range of the activation function of each layer of the original MLM from an updated maximum of an updated floating point range of the activation function of each layer of the updated MLM and determining the delta-min by subtracting an original minimum of the original floating point range of the activation function of each layer of the original MLM from an updated minimum of the updated floating point range of the activation function of each layer of the updated MLM.

14. The method of claim 11 wherein the updated integer zero point is determined by adding an offset to an original integer zero point of the original MLM, wherein the offset is determined by subtracting from an original minimum of an original floating point range of the activation function of each layer of the original MLM divided by an original scale of the original MLM, an updated minimum of an updated floating point range of the activation function of each layer of the updated MLM divided by an updated scale.

15. The method of claim 14 wherein the original integer zero point is determined by subtracting from an integer minimum of an integer range used for quantizing the respective activation function of the quantized MLM, a quantized minimum of a quantized floating point range of the activation function of each layer of the quantized MLM, divided by the original scale, and the original scale is determined by subtracting the original minimum of the original floating point range from the original maximum of the original floating point range, divided by the integer minimum of the integer range subtracted from an integer maximum of the integer range.

16. A method for partial quantization to achieve full quantized model comprising:
extracting a plurality of frozen quantized weights from each frozen layer of a quantized model, wherein the quantized model is generated by quantizing an original model;
quantizing a plurality of updated weights from an updated model to generate a plurality of updated quantized weights, wherein the updated model is generated by updating at least one layer of the original model to form at least one updated layer;
quantizing a respective activation function of each updated layer from the updated model from a difference between the original model and the updated model to generate a quantized activation function, wherein the difference comprises an updated scale and an updated integer zero point, the updated scale modifying an original scale used to quantize the original model with a ratio proportional to a floating point range difference between the updated model and the original model, and the updated integer zero point modifying an original integer zero point used to quantize the original model with a scaled difference between the floating point range minimums of the updated model and the original model; and
generating a new quantized model from the frozen quantized weights, the updated quantized weights and the respective quantized activation function of each updated layer.

17. The method of claim 16 further comprising training the updated model with a new dataset stored on an Edge device.

18. The method of claim 17 further comprising quantizing a plurality of weights and a respective activation function from each of a plurality of respective layers of the original model with a representative dataset, wherein the representative dataset is a subset of the new dataset.

19. The method of claim 16 wherein the updated model adapts to the new dataset through transfer learning.

20. The method of claim 16 further comprising inferencing with a neural processing unit and the new quantized model to perform transfer learning on an Edge device.
